(19) United States
(12) Patent Application Publication
(10) Pub. No.: US 2010/0012567 A1
(43) Pub. Date: Jan. 21, 2010

(54) Magnetic iron particle filter

(76) Inventor: Irving Bornstein, Avon, MA (US)

Correspondence Address: Irving Bornstein, 120 Packard Street, Avon, MA, 02322, US

(21) Appl. No.: 12/157,454

(22) Filed: Jul. 18, 2008

(51) Int. Cl. B03C 1/02; B03C 1/031

(52) U.S. Cl. 210/222

(57) ABSTRACT

The art to which this patent pertains is that no device exists in today's market to filter out fine metal particles which can slip past conventional “oil filter” filter elements. These fine metal particles contribute to engine ware. This invention extracts these particles using electromagnetism and stores them in a magnetic chamber which is strategically placed within the “invention”.

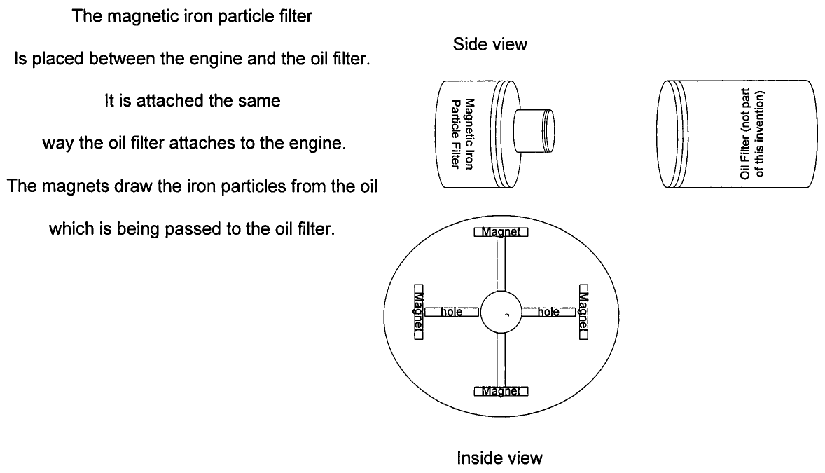

### CROSS REFERENCE TO RELATED APPLICATIONS

None

### STATEMENT OF FEDERALLY SPONSORED RESEARCH/DEVELOPMENT

None

### REFERENCE TO A “SEQUENCE LISTING”

None

### BACKGROUND OF THE INVENTION

New synthetic oils provide the most non abrasive lubricant for most types of machinery. However, the common oil filter does not filter out all of the impurities including metal particles created from friction between moving metal parts. By utilizing magnets strategically placed in a chamber, the iron particle can be filtered or extracted from the oil passing through the invention “Magnetic Iron Particle Filter”.

### BRIEF SUMMARY OF THE INVENTION

A process of separating iron particles from lubricants used in machinery, including gas and diesel engines. This device is attached to the engine in the same manner a standard oil filter is attached to the engine. Then a standard filter is attached to the new device. This invention provides additional protection against engine ware by eliminating the iron particles trapped in the lubricant.

### BRIEF DESCRIPTION OF THE DRAWING

The drawing is a cross-sectional view of the iron particle filter showing the basic components which consist of strategically place magnets within a chamber. In addition the magnets holes are drilled in the chamber to allow for the collection of fine metal particles which are extracted magnetically as oil is passed through the chamber.

### SUMMARY OF THE INVENTION

The present invention has been made to improve the life expectancy of machinery by removing metal impurities in lubricants which cause additional ware on moving parts. A basic technique magnetism is used, thus no moving parts are required to perform the filtering process. This invention is attached to machinery prior to attaching a normal oil filter product.

### DETAILED DESCRIPTION OF THE INVENTION

A metal chamber made of non magnetic material such as aluminum houses magnets placed at the end of predefined tubes or holes. As lubricant is allowed to pass through the central chamber the magnets pick up any magnetic material and clings it to the magnets. A threaded male and female connector is used to attach the device “Invention” to the engine and then to an oil filter. A rubber seal is also used on both sides of the “Invention” to seal the passing lubricant from leaking out.

What is claimed is:

1. A device comprising of a metal disk, iron magnets and a connection tube used to filter iron particles from lubricants. As oil is pumped through the invention, the magnets attract any metal particles within the cope of the magnetic field, thus removing unwanted particles. The location of the holes and the placement of the magnets create an environment whereas the unwanted metal particles can collect without being washed away by the lubricant passing through the invention. The actual size if the “Invention” will vary depending on the size of the machinery it is to be attached to in the same manor whereas a standard oil filters is attached to machinery today. The overall shape of the “Invention” will remain the same. The normal size range is 4 to 8 inches in circumference and 1 inch in diameter.
